(19) United States
(12) Patent Application Publication
(10) Pub. No.: US 2024/0238884 A1
(43) Pub. Date: Jul. 18, 2024

(54) DIGITALLY AUTOMATED FRAMING SYSTEM

(71) Applicant: BYLD IPCO LLC, Denver, CO (US)

(72) Inventors: Michael Lastowski, Centennial, CO (US); John Vanker, Lac du Flambeau, WI (US)

(73) Assignee: BYLD IPCO LLC, Denver, CO (US)

(21) Appl. No.: 18/286,651

(22) PCT Filed: Sep. 12, 2022
(86) PCT No.: PCT/US22/76264

§ 371 Date: Oct. 12, 2023

Related U.S. Application Data
(60) Provisional application No. 63/250,293, filed on Sep. 30, 2021.

(51) Int. Cl. B23D 59/00; B26D 7/06

(52) U.S. Cl. CPC B23D 59/008; B23D 59/001; B26D 7/0625

(57) ABSTRACT

A digitally automated system that eliminates the carpentry centric approach by integrating software and specialized machines to process light gauge steel framing members of different profiles so they can be assembled into wall sections without a carpenter referring to building plans, layout or manually marking and cutting. The machinery provides a receiving station where either tracks or studs are placed, measured and imprinted with unique indicia indicating the placement in a wall section and in the building. The tracks and studs are processed by other machinery that cut, punch, emboss and otherwise process the framing members. The processed framing members are bundled and assembled into wall sections for placement in the building. The software directs the imprinting of the unique indicia and selects the framing members that meet all necessary criteria.

### I. CROSS-REFERENCE TO RELATED APPLICATION

This application is based on and claims priority of provisional patent application 63/250,293, filed Sep. 30, 2021, and is fully incorporated herein by reference.

### II. BACKGROUND AND SUMMARY OF THE INVENTION

Carpentry is a skilled trade requiring years of apprenticeship or on the job training. There are primarily two types of carpentry—rough and finish. Rough carpentry involves the assembly of dimensional lumber or light gauge steel (LGS) framing members into structural and non-structural walls and floor sections of a building.

On-site rough carpentry is a manual process, involving reading building plans and laying out (using tape measures and various devices to set up angles) the location and position of wall and floor assemblies to meet the design specified in the building plans. Then each piece of framing material or framing members are measured, cut to size, fitted together, and fastened in place using nails (in the case of wood) or screws in the case of light gauge steel. This manual on-site carpentry centric approach dominates the industry.

The present invention eliminates this carpentry centric approach by integrating software and specialized machines to process light gauge steel framing members of different profiles so they can be assembled into wall sections without a carpenter referring to building plans, layout or manually marking and cutting. The invention described herein is faster, more accurate and reduces the need for specialized carpentry skills, saving time and money over conventional approaches to building framing.

### III. BRIEF DESCRIPTION OF THE DRAWINGS

FIG. 1 is a perspective view of a building structure illustrating the framing members in the structure.

FIG. 2 is a perspective view looking down one floor of the building structure of FIG. 1 showing the floor, walls and ceiling structural members.

FIG. 3 is a perspective view of a completed wall structure assembled from framing members processed from Applicant's inventive process.

FIG. 4 is a perspective view of another wall structure assembled from framing members process from Applicant's inventive process.

FIG. 5 is a front perspective view of a track profile

FIG. 6 is a front perspective view of stud profiles.

FIG. 7 is a perspective view of the framing members used to construct a wall and floor section with portions removed.

FIG. 8 is a front perspective view of the various components of the Digitally Automated Framing System.

FIG. 9 is a perspective view from the leading end of a computer controlled processing machine of the Digitally Automated Framing System consisting of three processing stations.

FIG. 10 is a perspective view from the tail end of the computer controlled processing machine of the Digitally Automated Framing System

FIG. 11 is an enlarged perspective view of the receiving station, lower station, and upper station of the processing machine for receiving stud and track profiles respectively.

FIG. 12 is an enlarged perspective view taken from the lead end of a stud and track being fed into the head tool.

FIG. 13 is a perspective view looking toward the lead end of the processing machine of the stud and track of FIG. 12 being fed into the head tool

FIG. 14 is a front perspective view of the caliper.

FIG. 15 is a perspective of the marking head from the tail end.

FIG. 16 is a right front corner perspective view of the station head tool for embossing, cutting and punching a track or stud.

FIG. 17 is a view of the exit end of the head tool for embossing, cutting and punching a track or stud.

FIG. 18 is an exploded perspective view of an embossed track and stud to be inserted into the track.

FIG. 19 is a perspective view of studs assembled on tracks and two tracks aligned for wall-to-wall or floor-to-floor assembly.

FIG. 20 is a perspective view of the storage or bundling racks.

FIG. 21 is a perspective view of the framing jig used for the building of wall sections.

FIG. 22 is a flow chart of the overall process implementing the inventive machinery.

FIG. 23 is a chart of industry standard stud sizing codes.

FIG. 24 is a flow chart that illustrates the initial steps in utilizing the digitally automated framing system.

FIG. 25 is a flow chart that illustrates the series from the generation of drawings to the delivery of fabricated materials to the job site.

FIG. 26 is a flow chart that illustrates the fabrication of the framing members.

### IV. SUMMARY OF THE INVENTION

The present invention is a digitally automated system that eliminates the carpentry centric approach by integrating software and specialized machines to process light gauge steel framing members of different profiles so they can be assembled into wall sections without a carpenter referring to building plans, layout or manually marking and cutting. The machinery provides a receiving station where either tracks or studs are placed, measured and imprinted with unique indicia indicating the placement in a wall section and in the building. The tracks and studs are processed by other machinery that cut, punch, emboss and otherwise process the framing members. The processed framing members are bundled and assembled into wall sections for placement in the building. The software directs the imprinting of the unique indicia and selects the framing members that meet all necessary criteria.

### V. DESCRIPTION OF THE PREFERRED EMBODIMENT

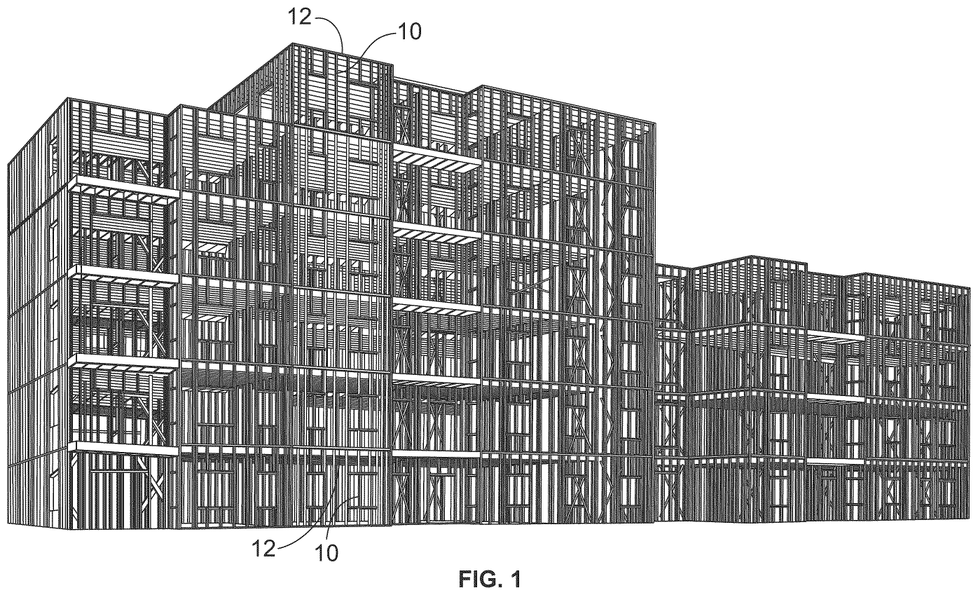

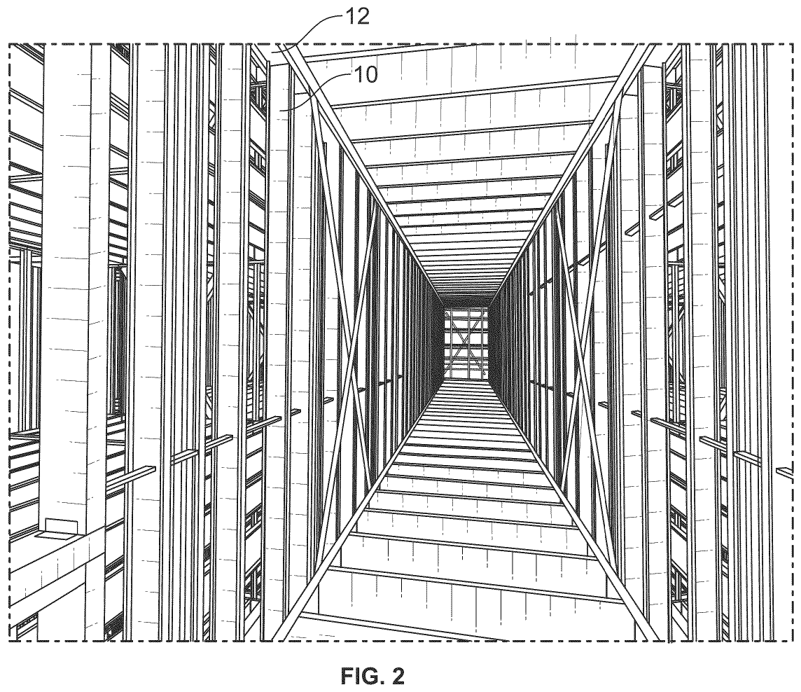

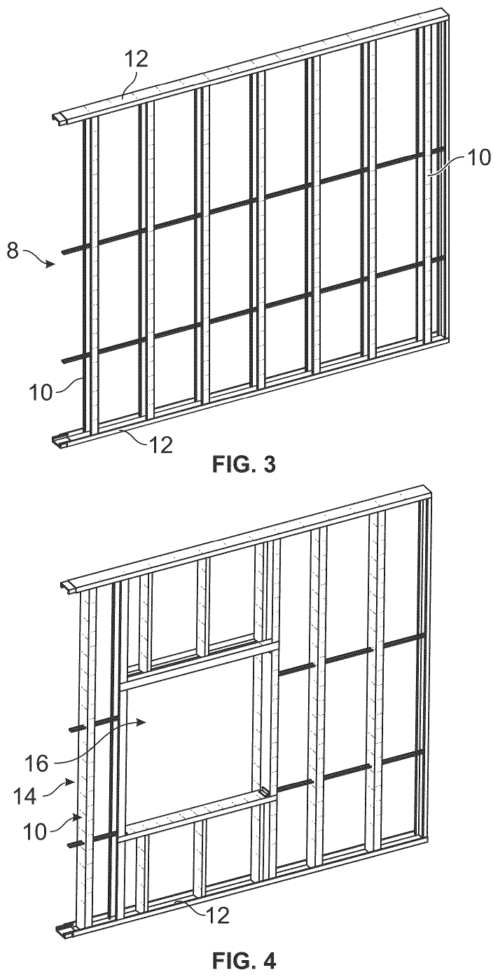

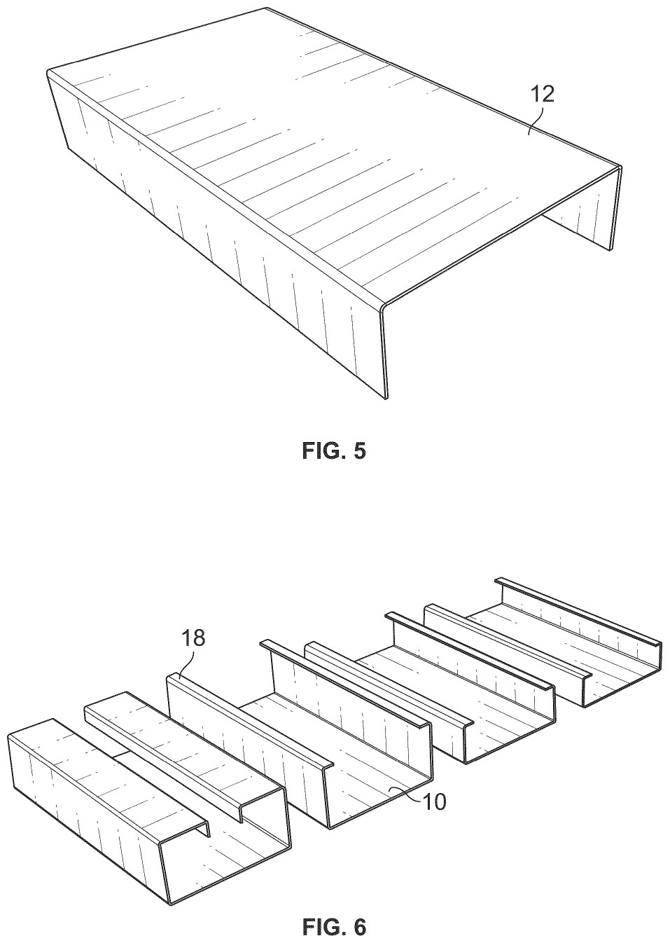

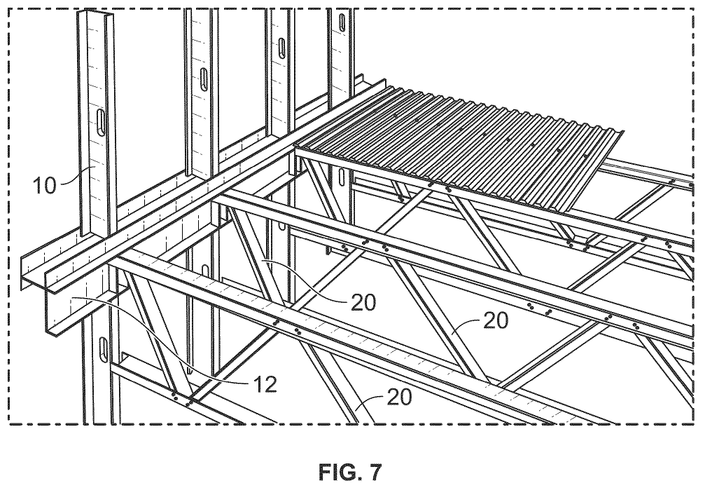

Turning first to FIGS. 1 and 2 there are illustrated various framing members used in the building structure. This invention addresses the processing of studs 10 and tracks 12. As seen in FIG. 3 there is illustrated a wall section 8 comprised of vertical studs 10 and horizontal tracks 12. Although the wall section & shows vertical studs 10, these may also be constructed with tracks 12 oriented vertically. FIG. 4 illustrates an alternate wall section 14, having an opening 16 for a window. This configuration still uses the same studs 10 and tracks 12 as the wall section 8, except fabricated at different lengths and potentially different gauges, as will be discussed in greater detail herein. FIG. 5 illustrates the track profile 12 and FIG. 6 illustrates the stud profile 10, the difference being that the stud profile 10 has an inward projecting lip 18. Stud profiles have a web and flange profile as seen in FIG. 6 with the inwardly projecting lip 18.

The assembly of the structural framing members is clearly shown in FIG. 7. Horizontal tracks 12 form the framework for the floors and the vertical tracks 12 form the structural framework for the walls. As previously mentioned, tracks 12 may also be used for forming the vertical framework when necessary. Various bracing members 20 may also be assembled into a floor truss and installed to form floor structures. The bracing members 20 may also be made from lengths of tracks 12 cut appropriately to fit between the horizontal tracks 12.

### Components of the Digitally Automated Framing System

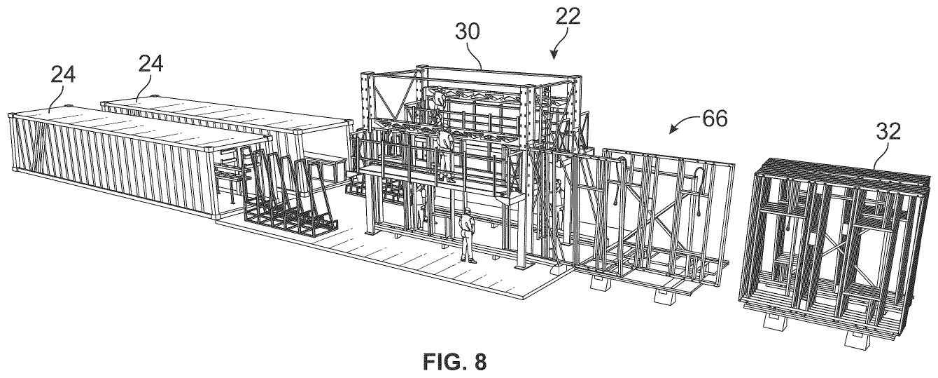

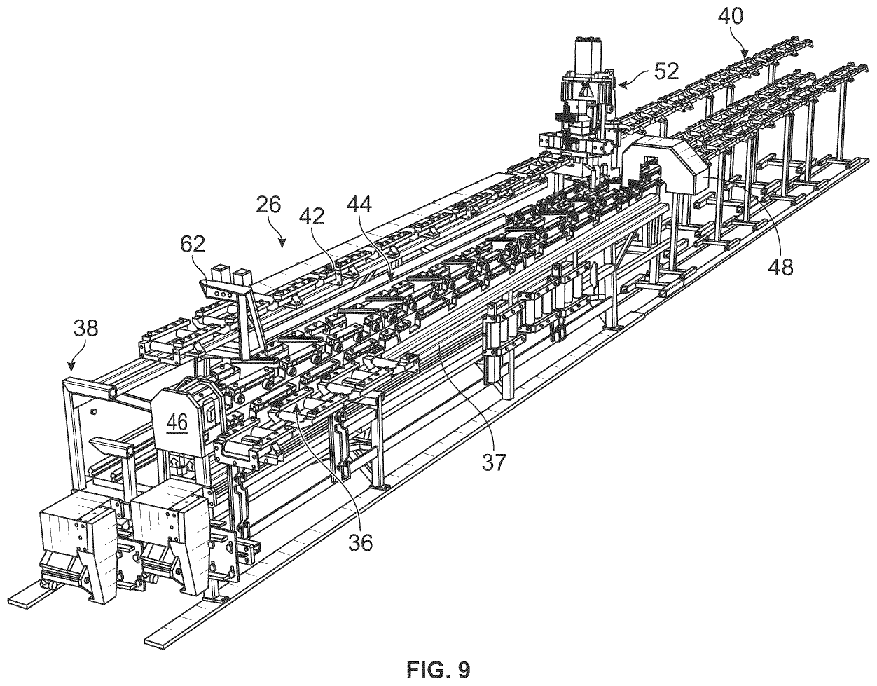

FIG. 8 illustrates an overview of the components comprising the Digitally Automated Framing System 22. There are containers 24 housing a processing machine 26 (see FIG. 9) and various processing equipment. The processed studs 10 and tracks 12 are assembled into wall sections 8 (see FIG. 3) in framing jigs 30. The assembled wall sections 8 are then placed in hoisting racks 32 for subsequent placement on the building. These components will be more fully described herein.

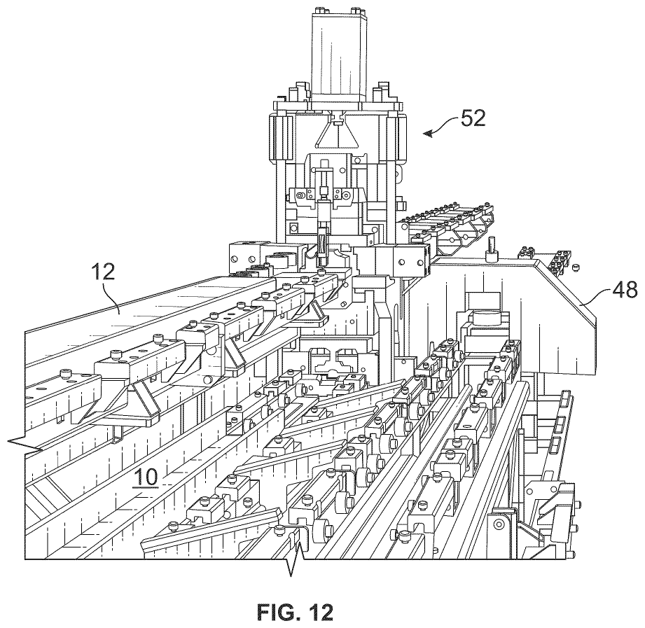

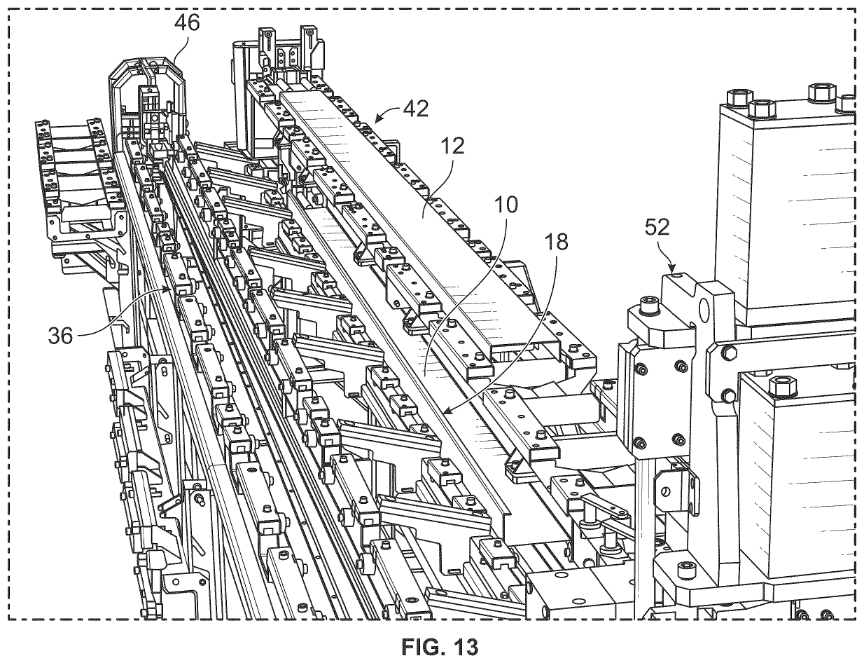

FIGS. 9 through 13 are perspective views of a processing machine 26 used to process the studs 10 and tracks 12. There is a receiving station 36, which receives the LGS framing member, which may be a stud 10 or a track 12, on a receiving track 37 as will be described herein. The processing machine 26 has a front end 38, a tail end 40, an upper or second station 42, and a lower or first station 44.

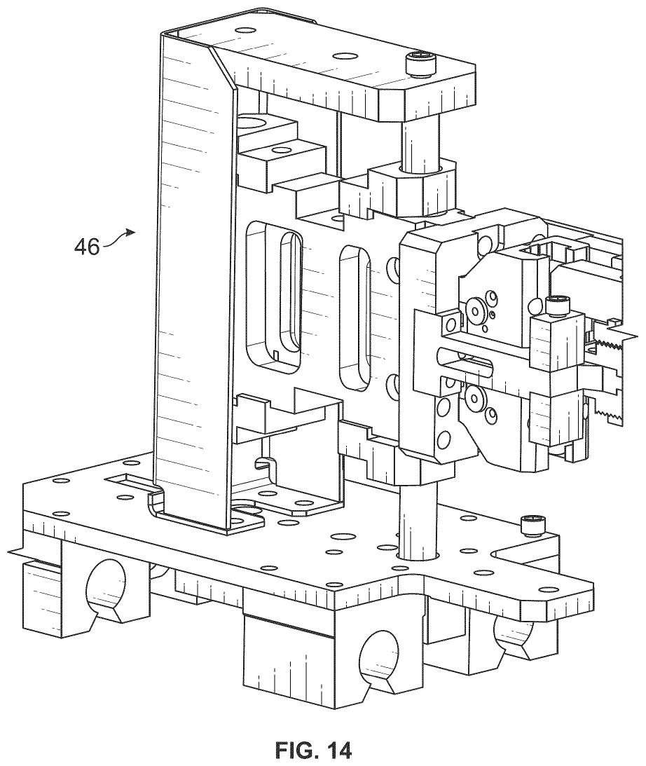

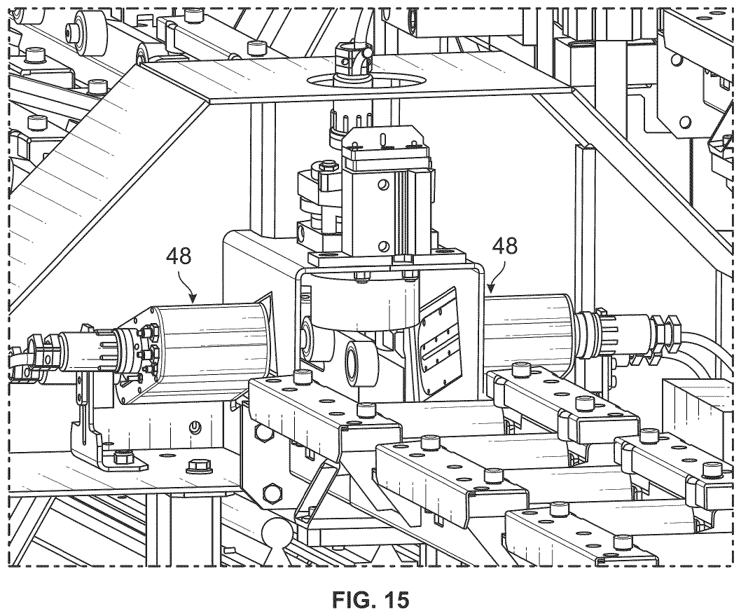

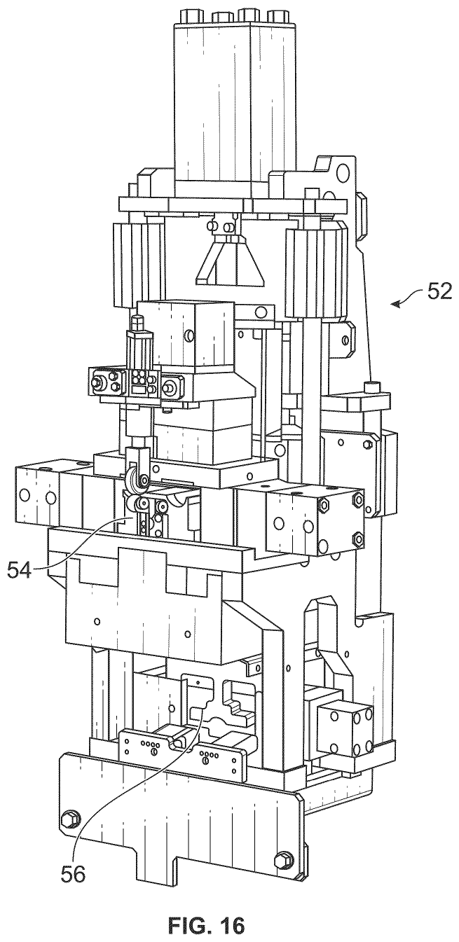

FIG. 14 illustrates a specialized caliper 46 at the front end 38 which among other functions, assesses the attributes such as the gauge of the stud 10 or track 12. A laser (not illustrated) mounted adjacent to the caliper 46 measures among other things the shape, web, flange dimensions, and lip dimensions of the LGS framing members.

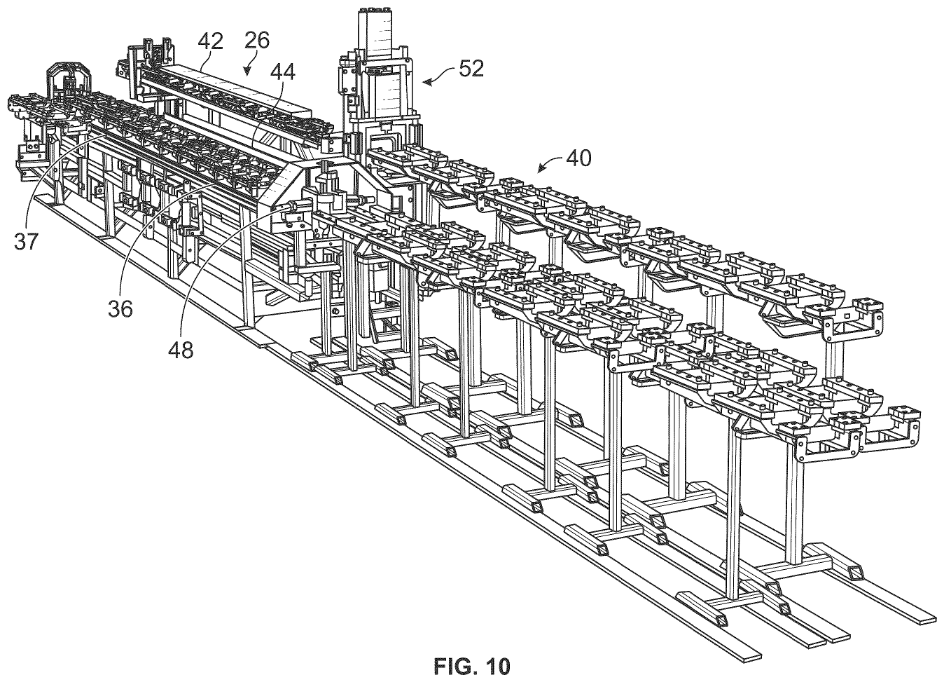

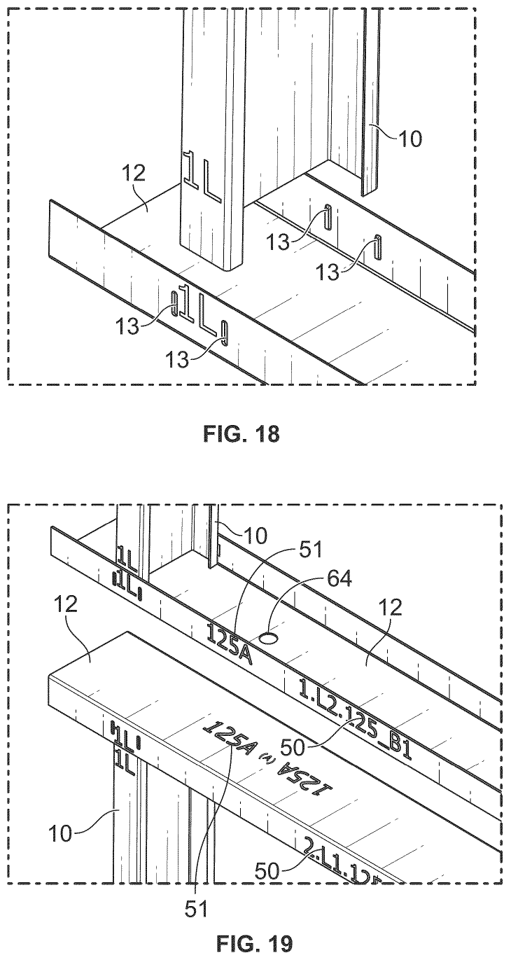

At the tail end 40 (FIGS. 9, 10) is a marking head 48 used to print member identifying information including specification and location information on all or one of three sides of each stud and track as will be described herein. The marking head 48 may be an inkjet printer, laser etching device, or any other device capable of printing, etching or imprinting identifying indicia on the framing member. Although throughout this application “marking head” may be used, it is meant to include any device capable of printing, imprinting or etching identifying indicia on the framing member. Furthermore where the term inkjet marking or ink marks, it is meant to include all forms of indicia such as laser etching. Examples of member identifying indicia is shown in FIGS. 18 and 19. In FIG. 18 the indicia “IL” is shown on both the horizontal track 12 and on the vertical stud 10. This illustrates the relationship of the inkjet marking on the track 12 and stud 10 and guides the assembly of the wall sections. The purpose, as will be explained more fully herein, is so that the installer knows that these two members are to be assembled together such as illustrated in FIG. 18. FIG. 19 illustrates other indicia 50, which is located on both tracks 12 showing that these two tracks 12 are to be joined at the locations indicated on the tracks. The indicia 50 is a unique code for each part used during the wall segment assembly process. The addition of this indicia is unique. It provides physical guides for aligning and connecting vertical studs 10 with horizontal tracks 12. This eliminates measuring at the jobsite for proper stud spacing and marking for screwing studs to tracks 12. The indicia 51 is used for wall segment to wall segment alignment when assembling the building vertically.

The ink marks used in this method of framing effectively replace manually placed pencil or wax marks carpenters use to show where members will be cut and fastened. The inkjet printing on the LGS framing members 10, 12 by digitizing precise information from plans, eliminates interpretive errors and speeds the process of construction, making the job of framing a building a routine task that laborers (not trained carpenters) can accomplish with speed and accuracy.

The upper station 42 as seen in FIGS. 9-11 is designed to receive and process top and bottom track 12 framing members which require further processing as opposed to the stock or pre-cut track members that require no further processing. Similarly, lower station 44 as seen in FIGS. 9-11 is designed to process wall stud 10 framing members that require further processing.

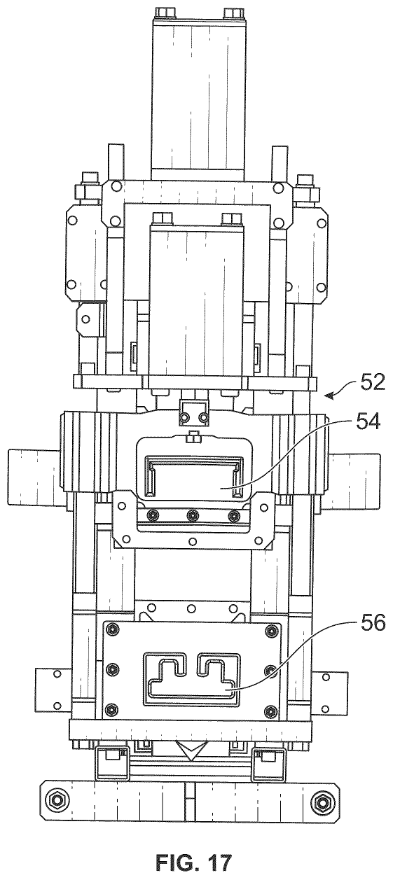

As illustrated in FIGS. 9-13, a head tool 52 is mounted at the tail end 40 of the processing machine 26. Embossing, various types of punching, and cutting to length all occur in the head tool 52. The head tool has two different configurations of guide slots. FIG. 17 illustrates an upper guide slot 54 and a lower guide slot 56 in the head tool 52. The upper guide slot 54 is used to process tracks 12 having a variety of different profile configurations such as gauge and flange height. The lower guide slot 56 is used to process studs 10 having a variety of stud profiles.

### Operation of the Digitally Automated Framing System

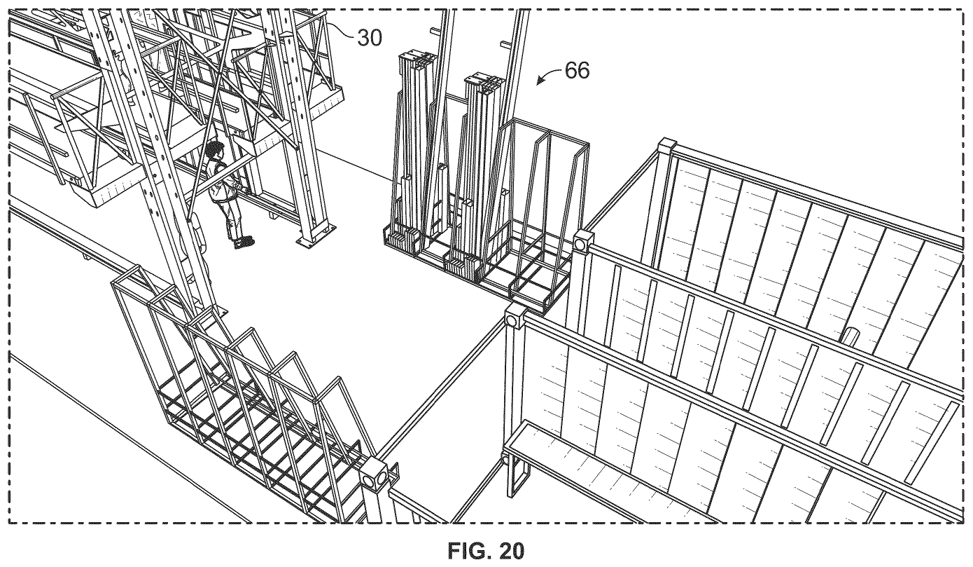

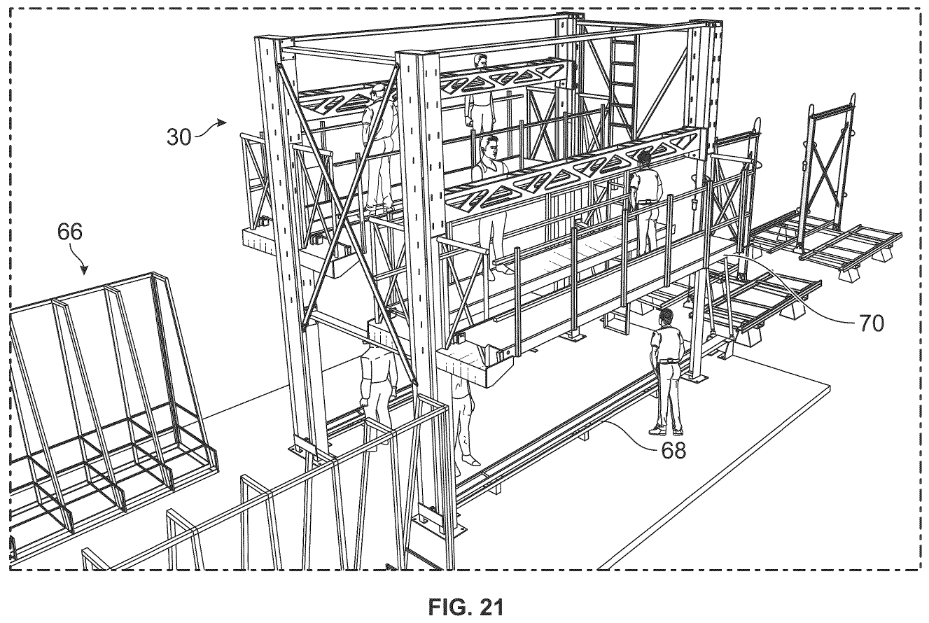

In operation, an operator stands in front of the receiving station 36. A parts schedule with a list of parts to be processed is displayed on a display screen (not illustrated) located adjacent to the processing machine 26 but out of the way of the operator as the operator is loading the stud 10 or track 12. The type of framing member, meaning stud or track, is indicated on the display screen. The operator then loads the type of profile to be processed on the receiving track 37. For example, assume the profile is a stud profile 10. The operator loads a stock stud member onto the receiving track 37. The caliper 46 has a clamping device that clamps onto the end of the stud 10 which not only clamps and holds the stud 10 firmly, but the caliper also measures the stud thickness to verify that it is the proper gauge to be processed. A laser (not illustrated) adjacent to the caliper 46 verifies the shape of the member. Assuming that the proper stud 10 has been placed on the receiving track 37, the caliper 46 pushes the stud 10 forward toward the tail end 40 through a measuring device 60 that measures the length of the stud 10. The length of each stud 10 is verified against data stored in the system's central controller to confirm that the length is what the stock piece is supposed to be. The stud 10 is pushed through the marking head 48 where the identifying indicia such as illustrated in FIGS. 18 and 19 unique to that stud 10 is printed in the proper locations on the stud 10. If additional processing of the stud 10 is required, the caliper 46 then withdraws the stud 10 back to its original position at the front end 38 of the receiving station 36. If no additional processing is required, the caliper 46 pushes the stud 10 through the tail end 40 for placement in a storage or bundling rack 66 (See FIGS. 20, 21).

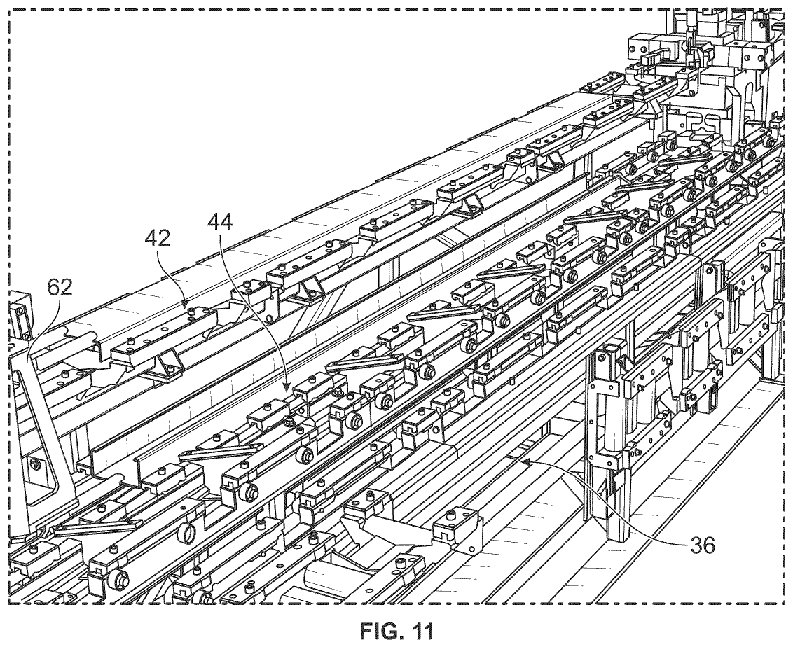

Assuming additional processing is required, the caliper 46 releases the clamping device holding the stud 10 and the operator lifts the stud 10 from the receiving track 37 and places it on the lower station 44, which is the station for processing studs. A guide clamp 62 (see FIGS. 9, 11) pushes the stud 10 along a track on the lower station 44 towards the tail end 40. The head tool 52 receives the stud 10 in the lower guide slot 56. The head tool 52 then performs the programmed processing on the stud 10. This includes one or more of the additional processing steps of embossing, cutting, or punching. This results in the proper length, embossing, or punching of each individual stud 10. Other machining tooling can also be designed and built into the head tool 52 to perform other procedures.

The processing of tracks 12 is the same as that described above for studs 10. The difference is that after the tracks 12 are measured and printed by the marking head 48, the tracks 12 are moved from the receiving station 36 to the upper station 42 for further processing.

Some studs 10 and track members 12 processed through receiving station 36 need no further processing. They are inventoried by the software for later assembly into wall sections with framing members that require further processing in upper station 42 or lower station 44.

The head tool 52 will process all industry standard profiles used to meet International Building Code (IBC) and local code based engineering requirements. By using industry standard profile materials, the invention described herein eliminates the limitations associated with proprietary profiles and proprietary building systems, cost of off-site manufacturing, limits of design flexibility, code compliance issues, etc. The head tool 52 is also designed to work with the many variations of tolerance in materials that are a result of manufacturing.

FIG. 18 illustrates an embossed track 12 with raised embossing 13. The embossing is done at upper station 42 as the guide clamp 62 moves the track 12 forward through the head tool 52.

Embossing is done at the sides of track 12 flanges at locations where other framing members will be inserted and attached. The embossing locations are determined by the software from the framing plans. This process eliminates layout, measuring and marking of framing members, the need for specialized carpentry skills, and enables precise location and attachment of framing members virtually eliminating the errors that occur when applying traditional framing practices.

Punching track guide holes 64 occurs in the head tool 52 at the tail end 40. Guide holes 64 are critical for aligning wall sections from floor to floor (see FIG. 19).

This significantly increases the rate at which a building can be erected. The final process in upper station 42 is cutting track 12 to the proper length. The software determines the length of the track member 12 by the length of the wall section in which it will be used.

As previously stated, lower station 44 is set up to process stud profiles 10. From the conversion of CAD information to digital code interpreted by the processing machine 26, the head tool 52 punches stud profiles 10 at precise locations where hold downs will be attached to laterally braced panels. Punching guide holes 64 for the framing of openings (doors, windows, and pass throughs) also occurs in the head tool 52 at lower station 44. Additionally, the head tool 52 can be programmed to punch holes in LGS studs 10 and tracks where other non-LGS building components are integrated, like tie rods and foundation imbeds. The final process in lower station 44 is cutting studs 10 to length. This processing of studs 10 is determined by digital interpretation of the plans by the software analyzing each member for its particular application and locations in the building. For example, studs 10 used in hallway sections of the building may receive hole punches for the attachment of lateral bracing (LGS strapping or LGS sheet panels) or stud members may be punched and cut to differing lengths based on which window or door openings they will be used to frame. The software described herein is effectively “kitting” the parts and issuing an assembly plan for the walls, and building.

To accomplish embossing, punching and cutting of the stud 10 and track 12 members the head tool 52 must perform multiple tasks at one station. To accomplish this the head tool has multiple hydraulic presses. The presses enable the head tool 52 to process all sides (web and flange) of LGS framing members.

Once track 12 and stud members 10 are processed, the software described herein inventories framing members for bundling with others that will be used to assemble specific wall sections, including framing members that were ink marked only in receiving station 36. The bundled members to be assembled into the specific wall section are placed in a storage or bundling rack 66 (see FIG. 20). Assemblers can then take the bundled members for a specific wall section, follow the ink marking and embossing, and assemble wall sections in the framing jig 30 without reviewing the plans. The assembled wall sections are then hoisted onto the building and the ink markings such as 50, 51, and guide holes 64 such as seen in FIG. guide their installation. For example, in FIG. 19, the numbers 125A are at the bottom of one track and at the top track of the wall below. Also as seen the reference “IL” on the stud aligns for insertion with “IL” on the track 12. The guide holes, alpha numeric markings, and embossing all guide the installation rather than the typical approach of measuring and marking the floor decking of the structure by referencing the plans. This results in a major reduction in the time to install a wall section, increases the accuracy of the installation, and allows laborers to install the wall sections rather than skilled carpenters.

The framing jig 30 is a unique structure for accurately assembling the wall sections. See FIG. 21. An assembler takes a bundle of members comprising the members for a specific wall section. One of the tracks 12 identified by its inkjet marking as a bottom track of the wall is placed on a jig receiving station 68 located along the bottom of the jig 30. The corresponding studs 10 that are to be assembled on the track 12 are inserted into the track 12. The identifying indicia on the studs 10 and tracks 12, along with the raised embossing 13 and any other locating indicia, allow the assemblers to accurately locate and assemble the individual studs and tracks into the wall sections without reference to any architectural or engineering plans. Assemblers stand on scaffolding 70 in order to place another track 12 that is the top of the wall section (or other top member of the particular structure as a window or door frame).

The jig receiving station 68 is on top of a hydraulic lift which raises and lowers the bottom track 12. The hydraulic lift raises the track 12 to firmly press the top and bottom tracks 12 together securely seating the studs 10 that are mounted between them. This eliminates non code compliant spaces between the end of a stud and the track in which it is mounted. The studs 10 are further secured by fasteners placed through the track 12 and complementary stud 10. Once the top and bottom tracks are securely seated, the hydraulic lift lowers the bottom track to relieve the compression and allow the completed wall section to be moved from the framing jig 30. Any additional bracing members, trusses or other members are attached by the assemblers until the wall section is completed in the framing jig 30. The assembled and completed wall section is then rolled off the jig receiving station 68 and placed in the hoisting rack 32 (FIG. 8). The wall sections for a specific location in the structure are all placed in hoisting rack 32 until that section of the structure is ready for assembly at which time the hoisting rack 32 is lifted and placed on the structure.

### Process Overview

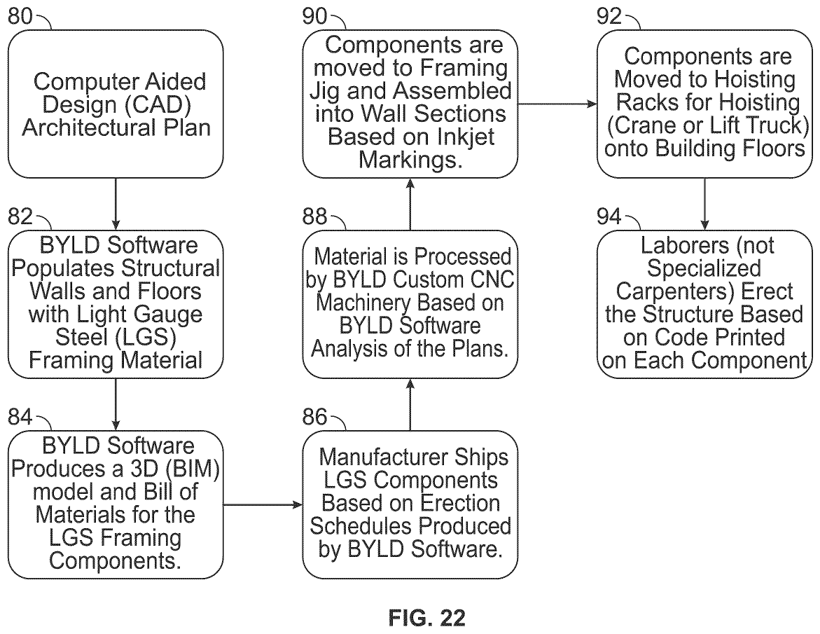

Turning to FIG. 22, the overall process implementing the inventive machinery is illustrated. In step 80, a third-party architect prepares the computer aided designs (CAD) architectural plans. In step 82, the computer software receives the CAD architectural plans and reviews the plans and building specifications for compliance with international building codes and local building codes. In step 82 the software calculates and selects the optimal LGS framing components for the studs 10, tracks 12, joists and trusses for the walls and floors and stores this information for later use. By individually calculating and applying the load calculations for each individual stud 10, track 12 and other components, the least gauge steel required for each of the studs 10, tracks 12, and other components for a particular wall or floor, are selected rather than the prior methods in which larger gauge steel components are uniformly selected as the load calculations for each individual component is not done.

At step 84 the engineering is complete and the software produces a three-dimensional building information model and bill of material which includes all of the LGS framing components including the studs 10 and tracks 12. As the bill of material has been generated, a purchase order is automatically generated to the manufacturer or supplier for the LGS framing materials. The software not only generates a bill of material, but also can be integrated with the manufacturer and supplier to generate an order and shipping schedule of the materials to the construction site. At step 86, the manufacturer or supplier of the LGS framing members produces and ships the LGS framing members based on the erection schedules supplied in step 84.

At step 88 the LGS framing members are processed by the Digitally Automated Framing System 22 as described above in the Description of the Preferred Embodiment. At step 88 the processed framing components analyze the specifications of each framing component, the LGS members have their unique codes applied by the ink jet printer 48, and the LGS member may be punched, cut, or embossed as the specifications dictate. The processed components are sorted by the software according to the wall section 8 in which they will be used and stored on the bundling racks 66 prior to being assembled in the framing jig 30 at step 90 according to their ink jet markings. Once assembled, the wall sections 8 are moved to a hoisting rack 32 at step 92 which is lifted onto the building and erected in place by the ink jet printed code on each section.

At step 94 the workers erect the walls and floors (or other marked LGS members) based on the ink jet printed indicia 50 on each of the LGS components. The workers are not specialized carpenters as all the field work normally done by the carpenters has been removed and replaced by the Digitally Automated Framing System 22.

### Detailed Description of Digitally Automated Framing System

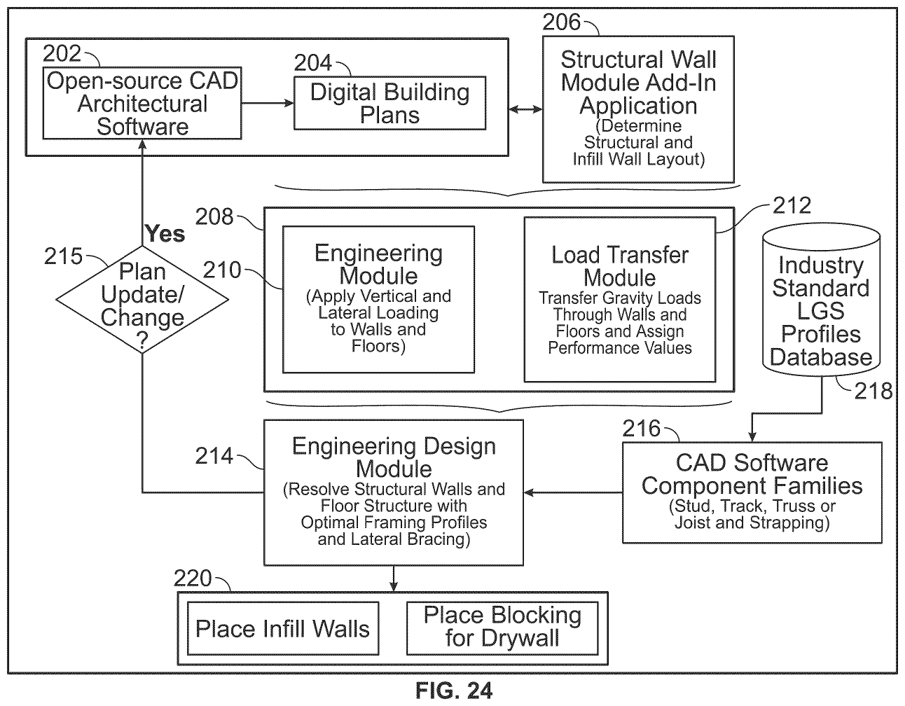

FIG. 24 illustrates a process where an architectural plan is converted to a detailed structural plan where each structural component in a building is sized and precisely placed in a specific location in a building, meeting the international and local building code requirements. FIG. 24 illustrates and describes the initial steps in utilizing the Digitally Automated Framing System.

In step 202 a third party architect has prepared a computer aided design (CAD) architectural plan. The architectural plan shows the location and dimension of the walls and floors of the building. At step 204 the architectural plans are converted into a 3 dimensional model by the software for processing by the rest of the software application as further illustrated in FIG. 24. At step 206 the software utilizes the 3 dimensional model created in step 204 to assess wall specifications, such as height, shape, and location, of the structural and non-structural walls and floors of the building.

In step 208 loads are applied to the walls, floors and roof of a building based on international and local building codes. Load path is assessed using required combinations-based criteria load path analysis—floor by floor from the roof to the foundation. Vertical and lateral loads are applied to the building in step 210, and in step 212 the load path through the building is analyzed.

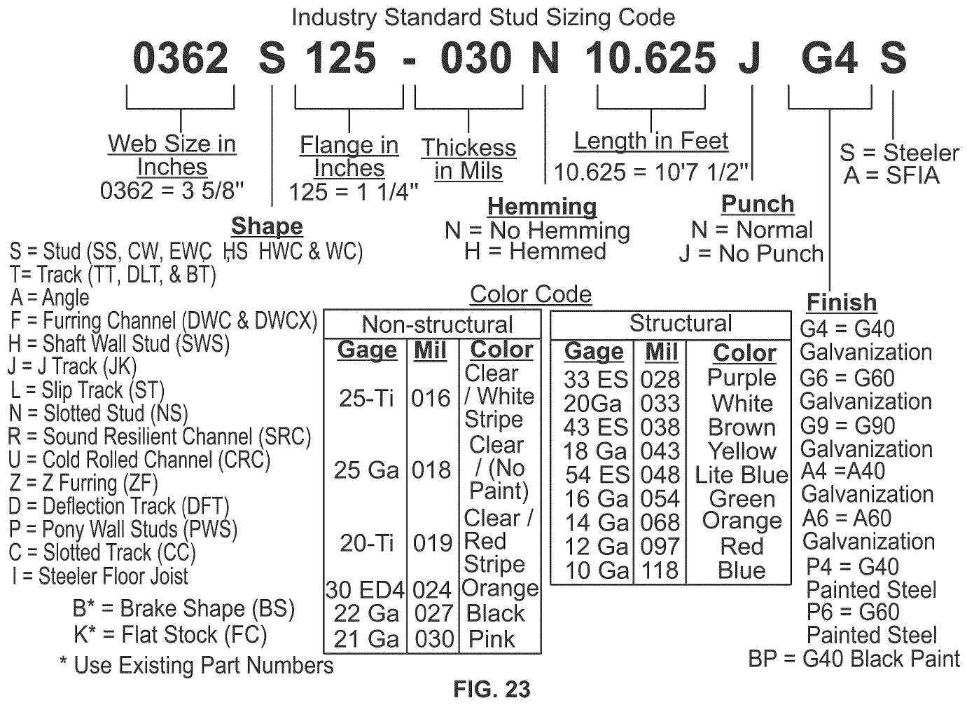

Once code based structural performance has been determined in steps 208, 210, 212, the software resolves the framing of the building in the engineering design module step 214 by selecting framing components in step 216, including studs, track, floor trusses or joists and lateral bracing (i.e. steel strapping) from a data base 218 of these materials built into the software. These framing materials are manufactured by third parties and meet American Iron and Steel Institute (AISI) cold-formed steel structural members industry standards such as illustrated in FIG. 23. If the building plan changes during the design development or by design changes in step 214, the changes are routed back through step 215 to steps 204 and to be updated and processed through steps 208-218 until finalized.

In resolving the structural framing, the engineering design module 214 sizes each component for optimal performance and precise location in the building. During optimization each wall stud 10 for example is sized for its optimal performance based on the gauge of steel and shape of stud 10 that best meets the vertical loading criteria. This is unique to the invention. For example, typical load bearing engineering design would call for the same gauge studs throughout a wall line or throughout the floor of a building because it is not practical, efficient or cost effective to analyze and draw each stud. This approach leads to the use of more material of a thicker gauge than required, which increases the weight of the structure, requiring more foundation and increasing the cost of the framing over the invention described herein. This invention results in selecting the optimum gauge of stud 10 and track 12, and other framing components, and thus decreases the weight and cost of the building.

The final step in this automated design process in FIG. 24 is step 216 whereby the building's non-structural infill framing and blocking and backing for drywall installation are resolved with light gauge framing components.

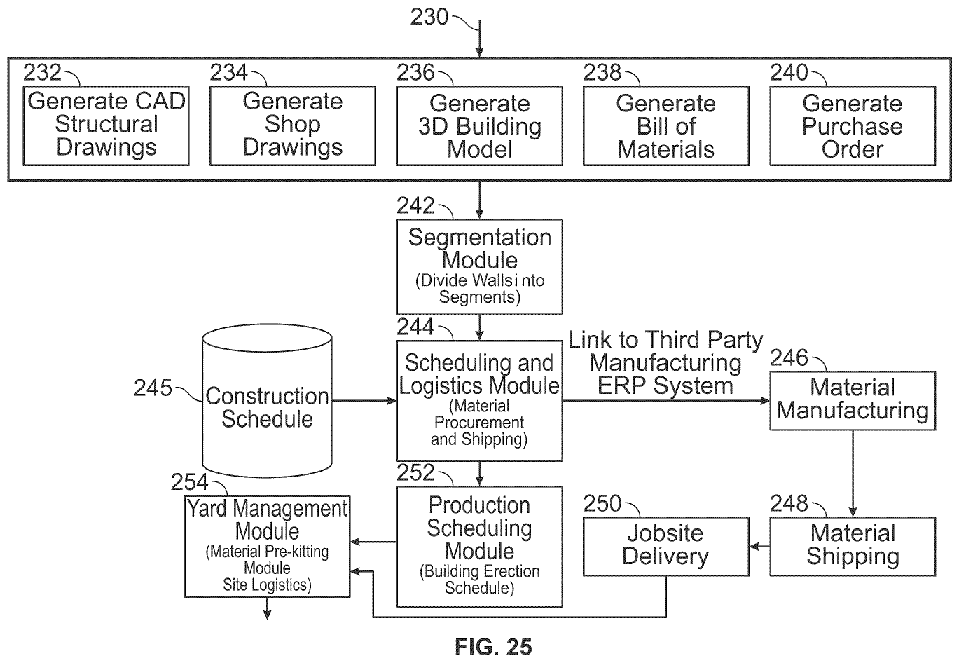

FIG. 25 illustrates the following steps in the fabrication and delivery of fabricated materials. A series of steps are undertaken in block 230. CAD structural drawings are prepared in step 232 for approval by the project's engineer of record. Shop drawings are prepared in step 234, and a three-dimensional structural framing model is prepared in step 236. A bill of materials is prepared in step 238 based on the model and framing specifications prepared in the previous steps. Once the bill of materials is prepared in step 238, a purchase order can be generated to procure the framing materials from third party manufacturers and suppliers in step 240.

In step 242 structural walls in the building are segmented for onsite assembly and erection into the building. Once the materials are specified, and the walls segmented, the materials are scheduled for manufacturing and procurement in step 244 based on the general contractors building schedule of 245. The scheduling and logistics step 244 links with a third-party manufacturer of LGS steel framing material and floor decking in step 246 at the third-party manufacturing location. The manufactured materials are shipped in step 248 and delivered to the jobsite in step 250.

Material shipping is based on a production schedule generated in step 252 and further refined and adjusted to “just-in-time” based on an agile yard management module 254 which controls the daily jobsite deliveries from step 250 based on the actual jobsite framing production (processing and erection of the building), which can vary due to site condition (weather, unforeseen delays, etc.) common during construction of a building.

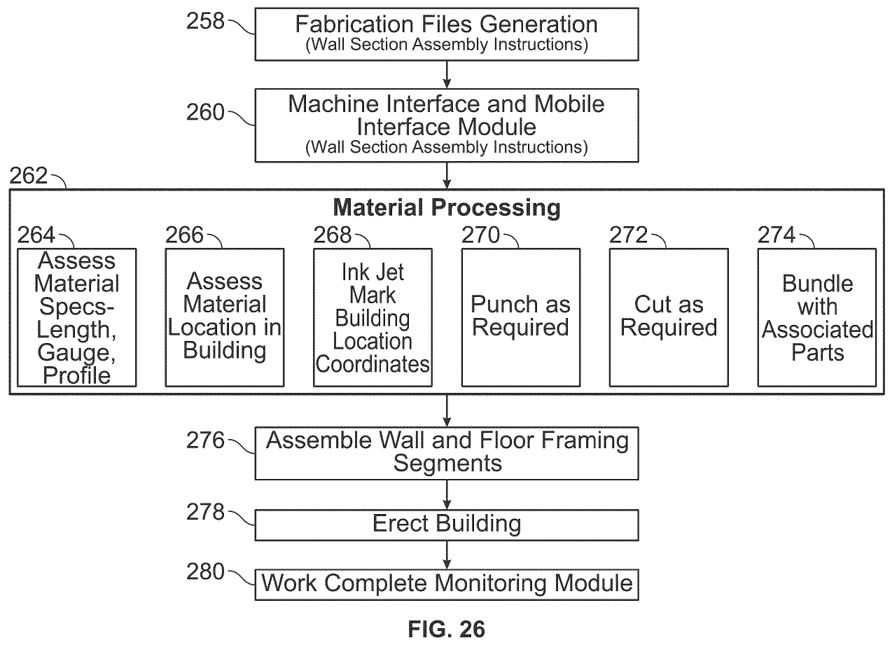

FIG. 26 illustrates the software modules that manage the processing, fabrication and installation of building framing. In step 258 the software manages digital machine file formats that operate a machine interface at step 260. This directs the various material processing which is illustrated in step 262. The various material processing includes one or more of the following options: material specification assessment such as length, gauge and profile at step 264; assess the material location in the building in step 266; determine ink jet code markings for the assembly and location coordinates in the building in step 268; determine punching in the material in step 270; determine if the material is to be cut in step 272; and determine the materials to be bundled with associated framing members in step 274. The information such as the selection of a stud 10 or track 12, is conveyed to the machine operator who selects the stud 10 or track 12 and places it in the receiving track 37 where the processing of the member in the processing machine 26 as previously described.

The processed framing members are assembled and moved to the storage and bundling racks 66 at step 276 based on the printed ink jet codes applied to the members in step 268. They are then assembled into the wall segments in the framing jig 30. At step 278 they are hoisted onto the building and erected into the building structural and infill walls. Step 280 is a monitoring module for site workers to process and monitor the erection of the framing as it progresses through final construction.

Thus there has been provided a digitally automated framing system that speeds the construction of framing walls in a building. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A building framing member processing machine comprising:
a front end and a tail end,
a receiving station with a receiving track for receiving a framing member which is to be processed and having a front end and a tail end,
driver means for engaging the framing member for pushing the framing member along the receiving track from the front end to the tail end, and for selectively pulling the framing member from the tail end to the front end,
marking means mounted in close proximity to the tail end of the receiving station for printing building positioning indicia on the framing member,
a first station having a front end and a tail end, the first station having a first station receiving track for receiving the framing members requiring metal machine processing,
second driver means for engaging the framing member on the first station receiving track for pushing the framing member from the front end to the tail end of the first station receiving track, and
a metal processing machine mounted at the tail end of the first station receiving track for metal processing of the framing member.

2. The building framing member processing machine of claim 1 wherein the driver means comprises a clamp for determining the thickness of the framing member when it is placed on the lower station receiving track.

3. The building framing member processing machine of claim 1 wherein the marking means comprises an ink jet printer.

4. The building framing member processing machine of claim 1 wherein the metal processing machine comprises a cutter for cutting the framing member to a predetermined length.

5. The building framing member processing machine of claim 1 and further comprising a second station having a front end and a tail end,
a second station receiving track for receiving the framing members requiring other metal machine processing,
third driver means for engaging the framing member on the second station receiving track for pushing the framing member from the front end to the tail end of the second station receiving track, and
a second metal processing machine mounted at the tail end of the second station receiving track for metal processing of the framing member.

6. The building framing member processing machine of claim 5 wherein the second metal processing machine comprises a metal embosser.

7. The building framing member processing machine of claim 6 wherein the second metal processing machine comprises a hole punch.

8. The building framing member processing machine of claim 5 wherein the second station is mounted above the first station which is mounted behind the receiving station and all are substantially horizontally parallel to each other.

9. The building framing member processing machine of claim 1 where the framing member is either a stud or a track and the receiving track is adapted for receiving either of the framing members.

10. A method for processing framing members comprising:
selecting at least one framing member to be processed,
placing the selected framing member on a receiving station,
moving the selected framing member through a marking device,
printing indicia on the selected framing member indicating a specific location on a building,
retrieving the selected framing member from the receiving station if the selected framing member requires further processing,
placing the selected framing member in a storage location if the framing member does not require further processing,
placing the selected framing member on a lower receiving track if the selected framing member requires further processing,
moving the selected framing member on the lower receiving track through a machining head and performing a machining operation, and
removing the further processed selected framing member from the lower receiving track and placing it in the storage location.

11. The method for processing framing members of claim 10 and further comprising:
providing an upper receiving track for receiving a second framing member,
moving the second framing member on the upper receiving track through the machining head and performing a second machining operation, and
removing the second processed framing member from the upper receiving track and placing it in the storage location.

12. The method for process framing members of claim 11 and further comprising:
displaying the parameters for the at least one framing member that is to be processed,
selecting the at least one framing member based on the parameters and placing the selected framing member on the receiving station.

13. The method for processing framing members of claim 11 and the further comprising bundling together the framing members comprising a wall structure.

14. The method for processing framing members of claim 13 and the further comprising placing the bundled framing members that comprise a wall structure into an assembling jig and constructing a wall section from the bundled framing members and locating the framing members on the wall section based on the printed indicia on the framing members.

15. The method for processing framing members of claim 14 and further placing the constructed wall section into the specific location in the building based on the printed indicia printed on the framing member.

16. A method for processing wall framing members comprising:
generating a three dimensional model based on a data file generated by an architectural software, where the three dimensional model includes three dimensional position information of the framing members in a building;
assessing wall specifications of all structural and non-structural walls and floors of the building;
applying loads to the structural and non-structural walls and floors;
determining the structural characteristics of the wall framing members based on the loads applied to the structural and non-structural walls and floors and based on building codes;
selecting optimal wall framing members based on the determined structural characteristics of the wall framing members; and
generating a second three dimensional model based on the selected optimal wall framing members.

17. The method for processing wall framing members of claim 16 and further generating a digital wall fabrication file containing the wall framing members for the processing of the wall framing members comprising a specific wall in the building.

18. The method for processing wall framing members of claim 17 and further transmitting information from the digital wall fabrication file to a framing member processing machine for imprinting information on the framing member designating the location of the framing member on a specific wall in the building.

19. The method for processing wall framing members of claim 18 wherein the transmitted information from the digital wall fabrication file further includes information for machining the framing member and processing the framing member by cutting the framing member to the proper length depending on its location in the specific wall.

20. The method for processing wall framing members of claim 19 wherein the transmitted information from the digital wall fabrication file further includes information for machining the framing member and processing the framing member by punching one or more holes in the framing member at a specific location in the framing member as specified in the digital wall fabrication file.

21. The method of processing wall framing members of claim 20 and further bundling together the processed framing members that are used to assemble a specific wall and assembling the wall using the imprinted information on the framing member designating the location of the framing member and the location of each framing member on the specific wall.
